(19) United States
(12) Patent Application Publication
(10) Pub. No.: US 2007/0251321 A1
(43) Pub. Date: Nov. 1, 2007

(54) Sensor, Sensor Arrangement and Measuring Method

(76) Inventors: Holger Fritze, Wernigerode (DE); Harry L. Tuller, Wellesley, MA (US)

Correspondence Address: WILLIAM COLLARD;COLLARD & ROE, P.C., 1077 NORTHERN BOULEVARD, ROSLYN, NY, 11576, US

(21) Appl. No.: 10/579,282

(22) PCT Filed: Nov. 13, 2003
(86) PCT No.: PCT/DE03/03774

§ 371 Date: Jan. 14, 2007

(51) Int. Cl. G01H 1/14

(52) U.S. Cl. 73/579

(57) ABSTRACT

The invention relates to a method and a device for detecting the environmental influence on a sensor by means of a variation of an electrical conductivity of a layer of the sensor, a device for detecting the environmental influence on sensors by detecting a variation of the electrical conductivity of a layer of the sensors, and a sensor device for detecting the environmental influence by means of a variation of an electrical conductivity of a layer of the sensor and by detecting a deposition inside the volume or on the surface thereof and/or the interaction of an environmental material or a substance to be measured on the same sensor.

The invention relates to a method and a device for detecting an environmental influence on a sensor, by means of a change in the electrical conductivity of a sensor layer of the sensor, as well as to an

arrangement for detecting an environmental influence on sensors by means of detecting a change in the electrical conductivity of a sensor layer of the sensors, as well as to a

sensor device for detecting an environmental influence by means of a change in the electrical conductivity of a sensor layer of the sensor, and by means of detecting a deposit built into the volume or a superficial deposit and/or the interaction of an environmental material or a substance to be measured on the same sensor.

Various environmental influences, such as gases, particles, or light beams, for example, prove to be hazardous for humans nowadays, even though they are present only in a small dose, e.g. in the case of biological or chemical production processes, as well as in certain living and working environments.

Various types of sensors were developed to measure these environmental influences, whereby these sensors use electrical, optical, acoustical, and electrochemical effects for the measurement. The measurement results can be used for monitoring and regulating machines and processes, for example measurement results of gas sensors, temperature sensors, or chemical sensors for conducting a chemical process.

Since the environmental influences to be detected frequently have only a slight extent, e.g. a low-power radiation or only slight amounts of a chemical substance, it was necessary to develop very sensitive sensors in order to detect these.

For this purpose, sensors that have a piezoelectric material have proven to be particularly useful. Using such sensors, it is possible to detect an environmental influence such as the reversible or irreversible deposit or accumulation of gases or particles in or on the sensor layer, for example. An adsorbed gas leads to a change in the measurement of the sensor, for example as a film on the sensor, causing its vibration frequencies to change. The changes in frequency prove to be directly dependent on the amount of the adsorbed gas.

A sensor having a piezoelectric material is known from US 2003/0076743 A1, on which two excitation electrodes having different sizes are disposed, by means of which the piezoelectric material is excited to vibrate. The sensor is dipped into an electrolyte in order to investigate the properties of the electrolyte, whereby the electrolyte acts directly on the excitation electrode.

In the case of such measurements, the electrode areas remain constant during a measurement. Another disadvantage is that the measurements of properties of an electrolyte, using such a sensor, is limited to the range of room temperature. Furthermore, it is disadvantageous that the electrolyte acts directly on the excitation electrode, and the latter undergoes changes as a result.

A high-temperature scale having a piezoelectric material, such as langasite, for example, is known from U.S. Pat. No. 6,370,955 B1. The frequency shift of the scale is observed in order to determine a change in a high-temperature environment by means of material deposited on the scale.

A disadvantage of this scale is that only the amount of the deposited material can be measured.

A piezoelectric resonator is known from WO 97/45723, in which excitation electrodes of different sizes are disposed, in order to excite the resonator to vibrate. In this connection, one of the electrodes can be covered by a polymer layer. The resonator is introduced into an organic solution, in order to detect chemical substances in it, whereby a change in the conductivity of the polymer layer and thereby in at least one resonance frequency and at least one anti-resonance frequency of the resonator is utilized. One disadvantage of this type of sensor is that it is designed only for the room temperature range. Another disadvantage is that polymer layers are used, so that only a limited bandwidth of environmental influences can be taken into consideration. Furthermore, it is disadvantageous that at least one resonance frequency and at least one anti-resonance frequency must be determined, in order to determine the type and the extent of the environmental influence, respectively, thereby making significant measurement technology structures and computer capacities necessary.

It is therefore the task of the invention to improve the selectivity and sensitivity of sensors, as well as to make available a simplified measurement method.

This task is accomplished, according to the invention, by means of a device for detecting an environmental influence on a sensor, by means of a change in an electrical conductivity of a sensor layer of the sensor, in accordance with claim 1, as well as by means of a corresponding method according to claim 16.

This task is furthermore accomplished by means of an arrangement according to claim 22, for detecting an environmental influence on sensors, by means of detecting a change in an electrical conductivity of a sensor layer of the sensors, whereby the arrangement has two devices according to claim 1.

The task is also accomplished by means of a sensor device according to claim 27, for detecting an environmental influence by means of a change in an electrical conductivity of a sensor layer of the sensor, and by means of detecting a deposit of an environmental material on the same sensor.

Advantageous configurations are shown in the dependent claims.

The following description of the general method of functioning of the sensor layer and of the production of resonance frequencies, as well as of the materials to be used, relates to all of the embodiments of the invention shown, in each instance.

The device according to the invention, in accordance with claim 1, and the method according to the invention, in accordance with claim 16, for detecting an environmental influence on a sensor, by means of a change in an electrical conductivity of a sensor layer of the sensor, are characterized, in comparison with the state of the art, in that only the resonance frequency of a fundamental tone needs to be determined, in order to determine the type and the extent of an environmental influence on the sensor. Furthermore, it is possible to cover a large temperature range, i.e. from −60° C. to 1000° C., preferably from −30° C. or 0° C. to 900° C. or to 600° C., 500° C., 250° C., or 100° C., as long as the material does not demonstrate any phase transition in this range. Therefore, even temperatures of up to −200° C. can be measured using the sensors according to the invention, i.e. the sensors can be used in the stated temperature ranges.

Furthermore, the sensor layer is not limited to a certain material, but rather can be formed by any and all materials that change their conductivity on the basis of an environmental influence to be determined.

In the case of the arrangement according to the invention, in accordance with claim 22, two devices having the same construction, in accordance with claim 1 (or one of claims 1 to 15) are exposed to the same environmental influence, but whereby only the first device delivers data that reflect the type or the extent of the environmental influence, and the second device remains untouched by this environmental influence. If one now compares the resonance frequencies of the fundamental tones with one another, the effect of the environmental influence (e.g. changed oxygen partial pressure) and changed environmental conditions (e.g. temperature increased to 900° C.) is reflected in the resonance frequency of the first device, whereas only the change in the environmental condition to be measured (i.e. the elevated room temperature of 600° C.) is reflected in the resonance frequency of the fundamental tone of the second device. In this document, the environmental influence is therefore the variable to be measured using the sensor. In this document, environmental conditions are understood to be the general physical, chemical, or biological conditions to which the sensor is exposed, which can possibly also change the frequency behavior of the sensor. In the case of the measurement device according to the invention, the environmental conditions are measured as a reference value and-eliminated in the measurement of the environmental influence that is of interest. In this way it is possible, in very simple manner, to find out the effect of the environmental influence on the resonance frequency of the fundamental tone, without previously having to carry out standard measurements or reference measurements for the sensor. The arrangement according to the invention is therefore ready for a measurement immediately, even if environmental influences and environmental conditions have not been measured previously, and does not have to be compared with a reference curve in order to be able to determine the type or the extent of the environmental influence. Furthermore, mechanical stresses in the sensor element, for example, which occur due to temperature changes in two sensor devices, can be separated from the desired signal that results on the basis of the environmental influence.

The sensor device according to the invention, in accordance with claim 27, is characterized in that for one thing, it comprises a sensor as defined in claims 1 to 15, so that the change in conductivity of a sensor layer of the sensor can be detected, in order to determine the type or the extent of an environmental influence on the sensor. The sensor of this embodiment additionally has a third excitation electrode, which makes it possible to also determine the amount of the material deposited on the sensor, using the same sensor. In this manner, this sensor device according to the invention serves, for one thing, as a sensor for detecting a change in the conductivity of the sensor layer, and for another thing, for detecting an amount of a material that has been deposited on or into the sensor.

For the device, the method, the arrangement, and the sensor device according to the invention, the following applies:

It is advantageous to use an oscillator circuit as the excitation unit, thereby making it more cost-advantageous to measure the environmental influence, or preferably, a network analyzer can be used, which records the entire resonance spectrum of the piezoelectric material, thereby also making available resonance frequencies of other upper harmonics, for example, or also damping of the resonance, in order to carry out a simpler temperature compensation by using the upper harmonics, for example, or to determine the viscosity of a material that has been deposited on the sensor, by using the damping.

It is advantageous if the excitation unit generates signals that run periodically, particularly rectangular, sine, or triangular signals, which are subsequently passed to the piezoelectric material.

The excitation electrodes can be formed from a metal, e.g. gold or aluminum (preferably at lower temperatures), a non-oxide ceramic, e.g. TiN, an oxide ceramic, e.g. La_{0.3}Sr_{0.7}CrO₃, or precious metals, e.g. Pt, Pt—Rh alloys (preferred for higher temperatures).

It is advantageous if the excitation electrodes lie directly against the piezoelectric material. However, layers of an insulation material and/or adhesive layers can also be disposed between the excitation electrode and the piezoelectric material, in order to prevent a chemical reaction of the two materials with one another, for example.

Preferably, the first excitation electrode lies against the piezoelectric material with an area that is greater than or smaller than the area with which the second excitation electrode lies against the piezoelectric material. If this variant is selected, a sensor layer that has the same construction for both sensors can be selected for the arrangement according to claim 22, but in the case of the first sensor, it is disposed on the larger excitation electrode, and is exactly as large as this excitation electrode, and in the case of the second sensor, it is disposed on the smaller excitation electrode, so that the sensor layer covers the smaller electrode completely, and beyond that also lies directly against a region of the piezoelectric material. In this manner, the result can be achieved that both sensors change their frequency behavior on the basis of general environmental conditions, but only the second sensor changes its frequency behavior on the basis of the environmental influence to be measured. This is because the effective electrode area is increased by means of the environmental influence in the case of the second sensor. In the case of this electrode according to the invention, the piezoelectric material is excited by means of the electrode area that lies against the piezoelectric material, and also by means of the sensor layer, since the latter demonstrates increased conductivity because of the environmental influence, and therefore the potential applied to the excitation electrode extends to the sensor layer. Consequently, excitation of the piezoelectric material occurs also in this region of the sensor layer. In other words, the environmental influence results in an increased conductivity of the sensor layer, thereby causing the potential of the excitation unit to be applied in the sensor layer, as well, and thereby causing the piezoelectric material to be excited to vibrate also by means of the sensor layer.

The reversal of the process, i.e. the reduction in conductivity of the sensor layer and therefore the reduction in the effective electrode area of the excitation electrode, can be used for the measurement, analogously, for example in the case of desorption of a material of the sensor layer.

It is advantageous if the excitation electrode(s) lie against the piezoelectric material with a circular area, so that particularly simple production of the sensor is possible.

Furthermore, the first excitation electrode and the second excitation electrode can have the same geometry, with additional electrical connectors, in each instance, so that no different excitation of the piezoelectric material due to geometry effects comes about. The excitation electrodes are preferably configured with the same construction, in particular, so that effects resulting from different geometries, materials, etc., do not occur.

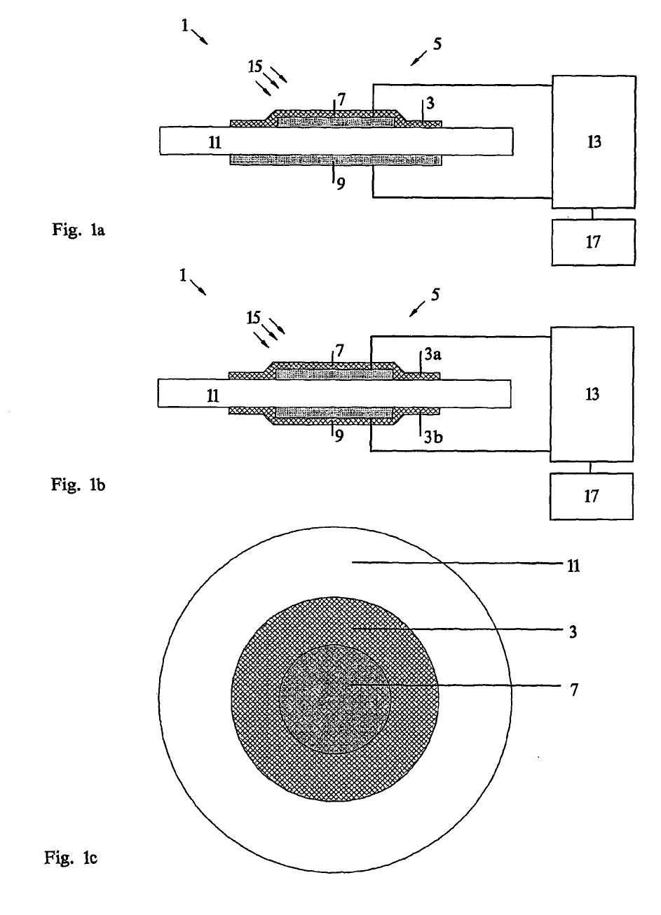

In another embodiment, the sensor is a resonator having excitation electrodes disposed on both sides, which are each coated with sensor layers. In this connection, it is also possible to configure the sensor layers from different materials and/or with different geometry. In FIG. 1b, such a sensor is shown schematically; the different sensor layers are designated as 3a and 3b.

In another embodiment of the invention, the area of the sensor layer can be changed in order to form a region of a sensor layer that is attuned to the opposite excitation electrode, by means of a change in geometry, for example as a ring element or a circular element. A change in resonance frequency can be brought about by means of this arbitrary change in the effective excitation area. Changes in resonance frequency can also be achieved in another manner, by means of varying the material of the sensor layer, in its entirety or only in segments. This measure serves to adapt the sensor to specific environmental conditions, or to produce a clear measurement signal for the environmental influence to be measured, respectively. As an example, a frequency shift can be adjusted by means of this variation in the area or the material of the sensor layer, which shift is adapted to specific temperature ranges or oxygen partial pressures to be measured.

The resonator can be formed from any desired piezoelectric material. Preferably, however, the piezoelectric material is quartz, a material having the structure Ca₃Ga₂Ge₄O₁₄ (langasite and its isomorphic compounds), a material of the system (Al, Ga)N or gallium orthophosphate, so that the sensor, the arrangement, and also the sensor device are capable of functioning in the high temperature ranges that are preferred according to the invention.

The piezoelectric material can fundamentally be present in any geometric shape. However, because of the production method and/or the measurement method, or the shape of a cylinder is preferred.

The sensor layer preferably lies directly against the at least one excitation electrode and/or the piezoelectric material.

The frequency measurement device can be a frequency counter or a network analyzer or impedance spectrometer.

It is advantageous if not only the resonance frequency of the fundamental tone but also at least one resonance frequency of upper harmonics and/or damping of the fundamental tone or the upper harmonic can be measured by means of the frequency measurement device, so that these are available for further evaluation. For example, temperature compensation can take place by using the resonance frequencies of the upper harmonics (e.g. as described in Phys. Chem. Chem. Phys., 2003: “High temperature bulk acoustic wave properties of langasite” by H. Fritze, O. Schneider, H. Seh, H. L Tuller, and G. Borchardt). Furthermore, damping of the resonance can be used in order to determine the mechanical properties, for example the viscosity, of materials deposited on the sensor, or of the sensor layer itself. The resonance frequencies of the upper harmonics can also be used to determine the type or the extent of the environmental influence.

Fundamentally, any and all types of external effects on the sensor layer are possible as an environmental influence. There is a limit only due to the fact that a material for the sensor layer must be found that reacts to the environmental influence with a change in its electrical conductivity:

Possible materials for the sensor layer are oxide ceramics, non-oxide ceramics, semiconductors, and organic synthetic or natural polymers, particularly ZnO, ZnS,TiO₂, Se, CeO₂, as well as oxides of transition metals, for example copper and iron, as well as proteins and nucleic acids. The person skilled in the art can select the suitable material for the sensor layer according to how it changes its electrical conductivity as a function of the environmental influence to be measured.

For measuring high-energy radiation such as photons, particle beams, radioactive rays, electron beams, and/or X-rays as an environmental influence, the material of the sensor layer consists of zinc oxide, for example. Electrons are raised into the conduction band of zinc oxide by means of the incidence of photons, so that this band demonstrates increased conductivity. Organic compounds can also be used, in place of semiconductors.

To measure a chemical or biological substance (3) as an environmental influence, a material that changes its conductivity when the substance comes into contact with the material of the sensor layer must be used for the sensor layer. This interaction of the substance with the sensor material results in a change in the mobility and/or the density of the charge carrier in or on the surface of the sensor material.

To measure a temperature change, a material must be used that changes its conductivity when it is heated or cooled. Semiconductors or ceramics are particularly possible for this purpose.

There are essentially three possibilities for undertaking temperature compensation of measured frequencies. As the first possibility, piezoelectric materials can be used, which have a temperature-compensating cross-section. As the second possibility, the temperature in the region of the measurement sensor can be measured by means of a thermometer or optical means, and subsequently the frequency shift due to the elevated temperature can be derived by “extrapolation,” for example using the temperature coefficient. Third, not only the resonance frequency of the fundamental tone of the piezoelectric material, but also at least one resonance frequency of an upper harmonic can be determined, and a temperature-compensated frequency value can be calculated using these two resonance frequencies (as, for example, according to Phys. Chem. Chem. Phys., 2003: “High temperature bulk acoustic wave properties of langasite” by H. Fritze, O. Schneider, H. Seh, H. L. Tuller, and G. Borchardt).

In one embodiment of the invention, two sensor elements are used, which are operated in a joint arrangement. The arrangement according to the invention, in accordance with one of claims 22 to 27, advantageously comprises two devices according to one of claims 1 to 15, which have the same construction with the exception of the position and size of the sensor layer, so that effects brought about by use of different piezoelectric materials, different excitation electrodes, different sensor layer materials, etc., do not have any influence on the measurement result. Because the structure is nominally identical except for the sensor layer position, the influences of the environmental conditions are eliminated, so that the desired measured variable for the environmental influence is lifted out.

Furthermore, it is advantageous if the piezoelectric materials are excited to vibrate by the same excitation unit, and it is advantageous if the vibrations of the piezoelectric material are counted by the same frequency counter. In general, it is therefore advantageous that the elements of the arrangement (according to one of claims 22 to 26), which do not have to be present in each of the two devices (according to one of claims 1 to 15) are used in common, whereby this furthermore results in a simpler structure and in cost savings.

The sensor device according to one of claims 27 to 31 can be structured with cylinder symmetry about an axis of symmetry. In this connection, the piezoelectric material has the shape of a cylinder, a first and second excitation electrode have the shape of a circular disk, whereby their center points lie on the same axis of symmetry, and the third excitation electrode has the shape of a circular ring, the circle center point of which also lies on the common axis of symmetry, and the sensor layer has the shape of a circular disk and lies directly on the first excitation electrode, whereby the center point of the latter also lies on the common axis of symmetry.

Preferably, here again (as also in the case of the device according to one of claims 1 to 15), the sensor layer lies directly against the excitation electrode, and the excitation electrodes lie directly against the piezoelectric material.

In the following, the invention will be described, making reference to a drawing, whereby:

FIG. 1a shows a schematic side view of a device according to the invention, for detecting an environmental influence on a sensor by means of a change in an electrical conductivity of a sensor layer of the sensor,

FIG. 1b shows a top view of the sensor of FIG. 1,

FIG. 1c shows another embodiment of the sensor according to the invention, in section,

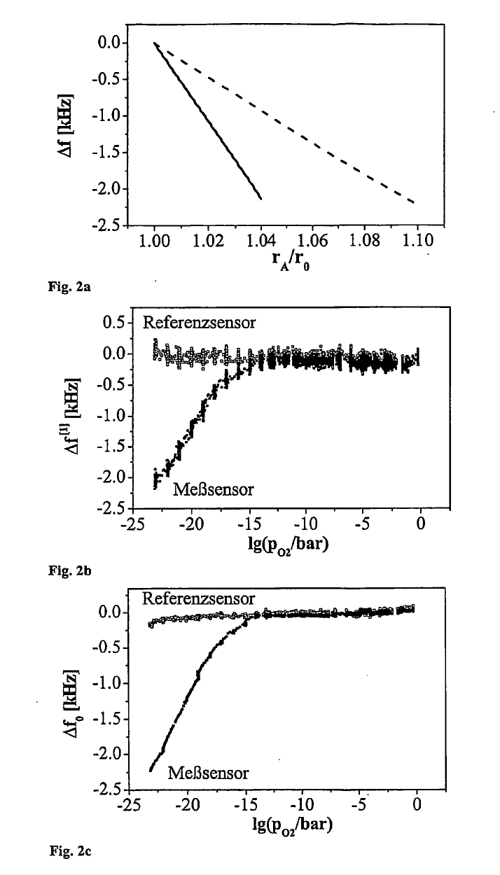

FIG. 2a shows a function plot that represents a calculated frequency shift on the basis of an enlarged effective electrode area,

FIG. 2b shows a first measurement with the device according to the invention of FIG. 1,

FIG. 2c shows the measurement of FIG. 2b with an improved temperature compensation,

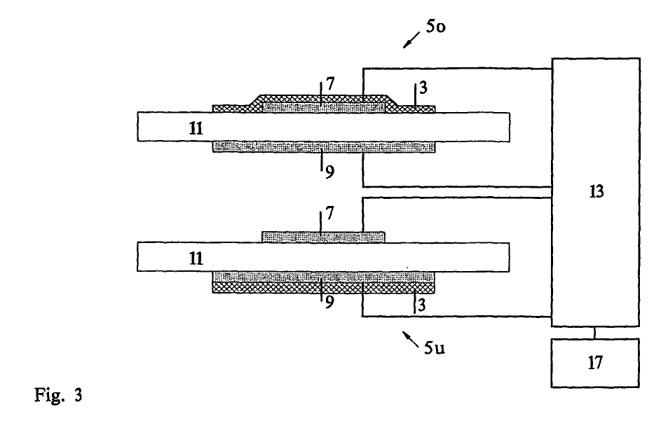

FIG. 3 shows a schematic side view of the arrangement for detecting an environmental influence on sensors, by means of detecting a change in an electrical conductivity of a sensor layer of the sensors, and

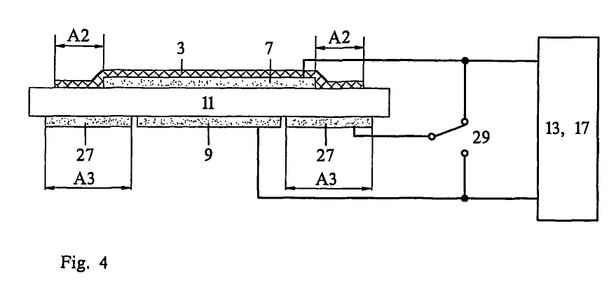

FIG. 4 shows a schematic side view of a sensor device according to the invention.

Fundamentally, different embodiments of the invention are possible. In the following, preferred embodiments of the invention will be described.

FIG. 1 shows an excitation unit 13 for generating electrical potentials, a sensor 5, and a frequency measurement device 17.

In the present case, the excitation unit 13 is formed by an oscillator circuit.

The sensor 5 consists of a first 7 and a second 9 excitation electrode, which are disposed directly on one side of a piezoelectric material 11, in each instance. A sensor layer 3 is applied directly on the first 7 and second 9 excitation electrode, which layer is identical on both excitation electrodes 7, 9, i.e. consists of the same material, has the same diameter and thickness, and therefore also the same mass.

The frequency measurement device 17 is a frequency counter, in the present case.

If the excitation electrode 13 generates oscillating potentials, these are applied to the piezoelectric material 11 by way of the first 7 and the second 9 excitation electrode, which material is thereby excited to vibrate. The piezoelectric material vibrates at a resonance frequency of the fundamental tone, as well as additional resonance frequencies of a first, third, fifth, and seventh upper harmonic, for example. The frequency of the vibrations of the piezoelectric material 11 is to be measured by means of the frequency measurement device 17.

A top view of the sensor 5 of FIG. 1 is shown in FIG. 2. The excitation electrodes 7, 9 and the piezoelectric material 11 are disposed concentrically here.

The conductivity of the sensor layer 3 can be varied by means of environmental influences. If the sensor 5 is exposed to an environmental influence, the conductivity of the sensor layer 3 changes. If the conductivity becomes greater, the potential applied at the first excitation electrode 7 becomes effective in the entire region of the sensor layer 3, since these are connected with one another in electrically conductive manner. The piezoelectric material 11 is therefore excited directly by means of the first excitation electrode 7, as well as by means of a region of the sensor layer 3, which is now more electrically conductive, thereby increasing the “effective electrode area” around the region of the sensor layer, which is now conductive. If a conductive sensor layer is present in the starting state, the conductivity can be reduced by means of an environmental influence to be measured, and thereby the effective electrode area can be reduced. The resonance frequency changes as a result of the change in the effective electrode area.

The following considerations determine the size of the excitation electrodes 7, 9:

In order to excite a sufficiently large volume of the piezoelectric material 11, the second excitation electrode 9 lies against a side of the piezoelectric material 11, with one surface, that approximates the size of this side of the piezoelectric material 11.

Thus, the upper limit of the effective electrode area of the sensor layer 3 is established as the area with which the excitation electrode 9 lies against the piezoelectric material 11: If the sensor layer 3 achieves sufficient conductivity, and the latter is at least as great as the electrode 9, then the effective electrode areas of the first excitation electrode 7 and the area of the second excitation electrode 9 that lies against the piezoelectric material 11 are equal. The conductivity then has a maximal effect, as the person skilled in the art can determine with simple experiments, if the entire region below the sensor layer is excited to vibrate.

The area of the sensor layer 3 that lies against the piezoelectric material 11 must be sufficiently large so that measurement data can be determined over a broad measurement range, using the sensor 5. However, it is not allowed to be so small that no sufficiently great area contact between the first excitation electrode 7 and the sensor layer 3 can come about any longer.

As a prerequisite for a sensor according to the invention, which only measures the change in the conductivity of the sensor layer, the area with which the first excitation electrode 7 lies against the piezoelectric material 11 is always smaller than the area with which the second excitation electrode 9 lies against the piezoelectric material 11.

The effect described above, of enlarging the effective electrode area, results in the frequency shift of the vibrating region of the piezoelectric material 11 that is now larger, as shown in FIG. 2a. In FIG. 2a, the calculated frequency shift (on the Y axis) is plotted relative to an enlarged effective electrode area, standardized to one in the starting state. In this connection, the solid line does not take into consideration any edge fields, which in turn were assumed at a certain extent when calculating the broken line. The edge fields are not a necessity for the effect that is used for the measurement according to the invention, but do influence it.

Therefore, a frequency shift of the resonance frequency of a fundamental tone (observed in an experiment) can therefore be used to determine the extent or the type of the environmental influence, since the frequency shift correlates directly with the extent of the environmental influence, and the frequency shift occurs only in the case of a certain environmental influence to be measured, or the particular type of the environmental influence.

Example for a Measurement Arrangement:

A langasite resonator was used as the piezoelectric material 11, and the excitation electrodes consist of platinum. The diameter of the excitation electrode 7 amounts to approximately 4 mm, and the diameter of the second excitation electrode 9 amounts to approximately 9 mm. The sensor layer 3 consists of TiO₂, and has a diameter of 7 mm.

When the piezoelectric material was operated at approximately 590° C., a drop in the oxygen partial pressure p_{O2} resulted in an increase in the TiO₂ conductivity. Since the region of the TiO₂ sensor layer 3 was larger than the first excitation electrode 7 of platinum, an increase in the TiO₂ conductivity resulted in an increase in the effective electrode area.

FIG. 2b shows the shift in the resonance frequency of the fundamental tone measured in this experiment, with filled symbols. The measured frequency shift is plotted on the Y axis, and the oxygen partial pressure is plotted on the X axis, in a logarithmic scale. As is evident from FIG. 2b, there is a clear change in the resonance frequency of the fundamental tone, particularly at very low oxygen partial pressure.

Likewise, FIG. 2b shows the behavior of a reference sensor having the same construction, with open measurement points. As is evident from FIG. 2b, there is hardly any change in resonance frequency in this sensor when the oxygen partial pressure drops.

Temperature compensation of the measured frequency values can take place as follows: The temperature prevailing in the region of the sensor 5 is measured by means of a thermometer or by means of optical methods. The effect that results from the increase in temperature can be calculated from the measured temperature, and can consequently be deducted from the measured frequency value. In this manner, a value for the resonance frequency of the fundamental tone is obtained, which is independent of the temperature and depends only on the oxygen partial pressure, and thereby the measured resonance frequency of the fundamental tone is temperature-compensated.

Once the measured function is known, the related oxygen partial pressure can immediately be derived for a predetermined frequency shift.

In the above description, a network analyzer was used as the excitation unit 13, and the entire frequency spectrum of the piezoelectric material 11 was recorded. Alternatively, an oscillator circuit can be used.

However, if the measurement is expanded by the resonance frequency of the fundamental tone and the resonance frequency of the third upper harmonic, for example, temperature compensation of the measured data can be carried out at high temperatures, as disclosed, for example, in Phys. Chem. Chem. Phys., 2003: “High temperature bulk acoustic wave properties of langasite” by H. Fritze, O. Schneider, H. Seh, H. L Tuller, and G. Borchardt.

FIG. 2c shows an improved temperature compensation for the same raw data that were also used in FIG. 2b. As was already evident from FIG. 2b, the change in conductivity results in a strong signal. The progression of the measurement of the reference sensor is again shown with open points, whereby the measurement signal tends to drop at a small oxygen partial pressure, while that of FIG. 2b tends to rise. This effect is due to the fact that temperature compensation reverses the sign of a dominating mass influence. (See also: Phys. Chem. Chem. Phys., 2003: “High temperature bulk acoustic wave properties of langasite” by H. Fritze, O. Schneider, H. Seh, H. L Tuller, and G. Borchardt).

As already described above, the method according to the invention, for detecting an environmental influence 15 on a sensor by means of detecting a change in the electrical conductivity of a sensor layer 3 of a sensor 5, can therefore be divided into the following steps:
1. Generating a fundamental tone in a piezoelectric material,
2. Measuring the resonance frequency of the vibration order of step 1,
3. Exerting an environmental influence (15) on the sensor layer (3), causing the conductivity of the sensor layer (3) to be changed and thereby causing the frequency spectrum of the piezoelectric material to be changed,
4. Measuring the vibration order after exertion of the environmental influence,
5. Calculating a resonance frequency difference that is formed from the difference of the resonance frequency of the vibration order of step 1 and the resonance frequency of the vibration order after changing the environmental influence, and
6. Correlating the extent of the environmental influence (15) with the resonance frequency difference.

The step of correlating the extent of the environmental influence 15 with the resonance frequency difference of the vibration order can be carried out using an existing measurement curve or by means of calculations. For a pure mass signal, the Sauerbrey equation can be used for evaluating conductivity changes, for example by means of calibration curves.

FIG. 3 shows an arrangement according to the invention, which is particularly advantageous, for detecting an environmental influence on sensors by means of detecting a change in an electrical conductivity by means of two sensors having different structures. The difference between the sensors, which otherwise have the same structure, consists in the fact that the sensor layer is applied to different excitation electrodes in a different expanse.

The arrangement comprises an excitation unit 13 for generating electrical potentials, two sensors 5o and 5u, and a frequency measurement device 17.

The piezoelectric material 11 and the first 7 and second 9 excitation electrodes of the sensors 5o and 5u have the same construction, in each instance, i.e. they consist of the same material and have identical spatial dimensions, among other things.

The upper sensor 5o in FIG. 3 has a sensor layer 3 that lies against the excitation electrode 7. In contrast to this, the lower sensor 5u in FIG. 3 has a sensor layer 3 that lies directly against the second excitation electrode 9.

The two sensor layers of FIG. 3 consist of the same material. The geometry of the sensor layers can be changed in order to adjust the response function of the sensors, as is described with reference to FIG. 1a.

If the sensor layers of the two sensors 5o, 5u of FIG. 3 are exposed to the same environmental influence, e.g. an electrolyte solution, the conductivity of the two sensor layers 3 is changed in the same manner. This has the result, in the case of the upper sensor 5o, that the effective electrode area changes and the frequency spectrum of the sensor 5o shifts. This has the result, in the case of the lower sensor 5u, that while the conductivity of the sensor layer 3 changes, this does not have any influence on the frequency behavior of the sensor 5u, since the sensor layer 3 of the lower sensor 5u does not have any contact area with the piezoelectric material 11. In other words, the change in conductivity has no influence on the frequency spectrum of the piezoelectric material 11, because only the second excitation electrode 9 and the first excitation electrode 7 of the sensor 5u excite the sensor to vibrate.

Therefore, although both sensors 5o and 5u are exposed to the same environmental influences and the same environmental conditions, only the frequency spectrum of the sensor 5o is influenced by the environmental influences and furthermore by the environmental conditions, while the frequency spectrum of the sensor 5u is changed only on the basis of the environmental conditions.

The sensor 5u, because it has the same construction as the sensor 5o, with the exception of the sensor layer, is the suitable reference sensor for attributing the frequency shifts of the sensor 5o to the frequency shift that is brought about by the environmental influence. In this manner, frequency shifts that result due to environmental conditions, e.g. a temperature change or due to the mass of the sensor layer 3, can be eliminated.

The measurement curves shown in FIGS. 2b and 2c were measured using the arrangement of FIG. 3.

FIG. 4 shows a schematic cross-sectional view of a sensor device according to the invention. The sensor device comprises a sensor having a cylinder of a piezoelectric material 11, a first 7 and a second 9 excitation electrode, as well as a sensor layer 3 that lies against the first excitation electrode 7 and the piezoelectric material 11. The second excitation electrode extends maximally over a region that is covered by the opposite first excitation electrode. The first excitation electrode is covered with the sensor layer that also extends onto the piezoelectric material. This sensor device furthermore has a third excitation electrode 27, which also lies directly against the piezoelectric material 11. In this connection, the third excitation electrode must cover at least the region that is covered only by the opposite sensor layer. Here, the excitation electrode 27 is configured in the shape of a circular ring, which is also disposed with cylinder symmetry, but other geometries are also possible, in order to adjust the vibration behavior.

Lines 21 proceed from the three excitation electrodes 7, 9, 27, which come together in a switching means 29. Using the switching means 29, either the excitation electrodes 7 and 27 or the excitation electrodes 9 and 27 can be connected with one another in electrically conductive manner.

In another embodiment, the third excitation electrode can be composed of several separate third partial electrodes, and be disposed on the opposite area regions of the resonator, the same or different sensor materials and/or geometries, in each instance. In this case of the division of the third excitation electrode into third partial electrodes, the individual partial electrodes must be contacted separately, and carried to the outside electrically, so that a multi-pole switching means allows optional switching in of individual or several third partial electrodes. In this manner, controlled switching in of sensor regions having different functionality, for example specificity for environmental influences to be measured, or other response behavior, becomes possible.

If the excitation electrodes 9 and 27 are connected with one another in electrically conductive manner, these two excitation electrodes 9, 27 act approximately like a single excitation electrode. In this case, the sensor device 27 acts like the sensor 5 according to FIG. 1a described above. Therefore, environmental influences that influence the conductivity of the sensor layer 3 can be detected with a sensor device 25 switched in this manner.

If the excitation electrodes 7 and 27 are connected with one another in electrically conductive manner, the excitation electrodes are disposed in such a manner that the size of the electrode 9 in FIG. 4 determines the vibrating region of the piezoelectric material 11. A deposit of a material (as an environmental influence on the sensor device 25) changes the vibration behavior of the sensor device, so that again a conclusion concerning the mass of the material that is deposited can be drawn from the change in resonance frequency of fundamental tone or upper harmonics.

Depending on how the switching means 29 is switched, the sensor device 25 serves as a sensor that reacts to a change in a conductivity of the sensor layer 3, or as a sensor that indicates the mass of a substance deposited on it.

Switching between these two “sensors” or these two “sensor functions,” respectively, takes place instantaneously, so that supplemental information about the type (about the conductivity) and the extent (about the mass deposit in or on the sensor layer) of the environmental influence is available.

In the case of this embodiment, as well, it is advantageous that the conductivity of the sensor layer can be measured, in general, with measurement devices that already exist, for resonant sensors, for example such gas sensors, even if only a simple switching means is used in addition.

As described in this document and already above, the use of quartz, of langasite and its isomorphous compounds, piezoelectric materials of the system (Al, Ga)N, or of gallium orthophosphate as the piezoelectric material is preferred, so that the piezoelectric material of the device, the arrangement, and the sensor device is capable of functioning even at high temperatures.

In order to be able to operate the sensor device even at high temperatures, it is advantageous to use materials for the excitation electrodes 7, 9, 27 that guarantee ability of the sensor device 25 to function even in the range of these high temperatures. These are, in particular, ceramics, non-oxide ceramics, oxide ceramics, or precious metals.

It is advantageous if an oscillator circuit serves as the excitation unit 13 for the sensor device 25, if necessary also for higher upper harmonics, thereby making it possible to structure the production of a measurement apparatus in cost-advantageous manner, or preferably a network analyzer, which records the entire resonance spectrum of the piezoelectric material 11, thereby making additional resonance frequencies (of fundamental tones or upper harmonics) available for further evaluation.

### REFERENCE SYMBOL LIST

1 device for detecting an environmental influence on a sensor
3 sensor layer
3a, 3b different sensor layers
5 sensor
5o upper sensor in FIG. 3
5u lower sensor in FIG. 3
7 first excitation electrode
9 second excitation electrode
11 piezoelectric material
13 excitation unit for generating electrical potentials
15 environmental influence (e.g. photons or chemical substances)
17 frequency measurement device
19 cylinder segment of the piezoelectric material
21 line
23 arrangement for detecting an environmental influence on sensors
25 sensor device for detecting an environmental influence
27 third excitation electrode
29 switching means

1. Device for detecting an environmental influence (15) onto a sensor (5), by means of detecting a change in an electrical conductivity of a sensor layer (3) of the sensor (5), wherein the sensor (5) has a first (7) and a second (9) excitation electrode, a piezoelectric material (11), and a sensor layer (3), which comprises: an excitation unit for generating electrical potentials (13), which are passed to the piezoelectric material by way of the first (7) and the second (9) excitation electrode, whereby the sensor layer (3) lies against both at least one excitation electrode and the piezoelectric material, at least in sections, and the sensor layer (3) has a conductivity that is dependent on environmental influences, so that the piezoelectric material can be excited to vibrate by means of the excitation electrodes and the sensor layer (3), wherein a frequency measurement device (17) makes it possible to detect a vibration order of the piezoelectric material.

2. Device according to claim 1, wherein the excitation unit (13) is formed by means of an oscillation circuit or a network analyzer.

3. Device according to claim 1, wherein the excitation electrode is formed from a metal, a non-oxide ceramic, oxide ceramic, or a precious metal.

4. Device according to claim 1, wherein the excitation electrode lies directly against the piezoelectric material.

5. Device according to claim 1, wherein the first excitation electrode (7) lies against the piezoelectric material with an area that is as large as an area with which the second excitation electrode (9) lies against the piezoelectric material.

6. Device according to claim 1, wherein the first excitation electrode (7) lies against the piezoelectric material with an area that is larger than or smaller than an area with which the second excitation electrode (9) lies against the piezoelectric material.

7. Device according to claim 1, wherein the excitation electrode(s) lie against the piezoelectric material with a circular area.

8. Device according to claim 1, wherein the first excitation electrode (7) has a same geometry as the second excitation electrode (9).

9. Device according to claim 1, wherein the piezoelectric material is formed from a quartz, from langasite, its isomorphous compounds, or from gallium orthophosphate, or is a piezoelectric material that is capable of functioning even at temperatures up to 1000° C.

10. Device according to claim 1, wherein the piezoelectric material has the basic shape of a cylinder.

11. Device according to claim 1, wherein the sensor layer (3) lies directly against the at least one excitation electrode and/or the piezoelectric material.

12. Device according to claim 1, wherein the sensor layer (3) is configured in circular shape.

13. Device according to claim 1, wherein the sensor layer (3) contains oxide ceramics, non-oxide ceramics, semiconductors, organic synthetic or natural polymers, ZnO, ZnS, TiO2, Se, CeO2, oxides of transition metals, proteins or nucleic acids.

14. Device according to claim 1, herein the frequency measurement device (17) comprises a frequency counter.

15. Device according to claim 1, wherein the vibration order is the first, third, fifth, or higher.

16. Method for detecting an environmental influence (15) on a sensor by means of detecting a change in the electrical conductivity of a sensor layer (3) of the sensor, using a device according to claim 1, which comprises the following steps:
1. Generating a fundamental tone in a piezoelectric material,
2. Measuring the resonance frequency of the vibration order of step 1,
3. Exerting an environmental influence (15) on the sensor layer (3), causing the conductivity of the sensor layer (3) to be changed and thereby causing the frequency spectrum of the piezoelectric material to be changed,
4. Measuring the vibration order after exertion of the environmental influence,
5. Calculating a resonance frequency difference that is formed from the difference of the resonance frequency of the vibration order of step 1 and the resonance frequency of the vibration order after changing the environmental influence, and
6. Correlating the extent of the environmental influence (15) with the resonance frequency difference.

17. Method according to claim 16, wherein upper harmonics are also generated and measured in the piezoelectric material, which are also taken into consideration in detecting the type or the extent of the environmental influence (15).

18. Method according to claim 16, wherein the resonance frequencies of the upper harmonics serve for a temperature compensation of the vibration behavior of the piezoelectric material.

19. Method according to claim 16, wherein exerting an environmental influence (15) comprises irradiation of the sensor layer (3) with high-energy radiation.

20. Method according to claim 16, wherein the environmental influence (15) is the effect of a chemical or biological substance on the sensor layer (3), or a temperature change.

21. Method according to claim 16, wherein signals that run periodically, particularly rectangular, sine, or triangular signals, are passed to the piezoelectric material by the excitation unit (13).

22. Arrangement (23) of a first sensor (5o) and a second sensor (5u) for detecting an environmental influence (15), whereby the first sensor (5o) has a first (7) and an opposite second (9) excitation electrode, a piezoelectric material (11) disposed between these, and a sensor layer (3) that covers the first excitation electrode (7) and also the piezoelectric material (11) at least in sections, and the sensor layer (3) has a conductivity that is dependent on environmental influences (15), so that the piezoelectric material (11) can be excited to vibrate by means of electrical potentials from the excitation unit for generating electrical potentials (13), both by way of the excitation electrodes (7, 9) and by the sensor layer (3), and the resonance frequency of a vibration order of the piezoelectric material (11) can be detected by means of a frequency measurement device (17), and
the second sensor (5u) has a first (7) and an opposite second (9) excitation electrode, a Piezoelectric material (11) disposed between these, and a sensor layer (3) that covers the excitation electrode (9) at least in sections, but does not exceed it, and the sensor layer (3) has a conductivity that is dependent on environmental influences (15), wherein the sensor layer (3) is disposed in such a manner that the piezoelectric material (11) can be excited to vibrate exclusively by means of the excitation electrodes (7, 9), and the resonance frequency of a vibration order of the piezoelectric material can be detected by means of a frequency measurement device (17).

23. Arrangement according to claim 22, wherein the piezoelectric material (11) in the first sensor (5o) is identical with that of the second sensor (5u).

24. Arrangement according to claim 22, wherein the materials of which the excitation electrodes of the first and second sensor (5o, 5u) consist are identical.

25. Arrangement according to claim 22, wherein the material of which the sensor layer (3) of the first sensor (5o) is formed is identical with the second material of which the sensor layer (3) of the second sensor (5u) is formed.

26. Arrangement according to claim 22, wherein the geometry in which the sensor layer (3) of the first sensor (5o) is shaped is identical with the geometry in which the sensor layer (3) of the second sensor (5u) is shaped.

27. Sensor device (25) for detecting an environmental influence (15), having a first (7) and a second (9) excitation electrode, a piezoelectric material (11) disposed between these, and a sensor layer (3), wherein the first excitation electrode (7) is disposed on a first side of the piezoelectric material (11), and the second excitation electrode (9) is disposed on the opposite, second side of the piezoelectric material, and the sensor layer (3) lies against the first excitation electrode (7) with a first partial area A1, and against the piezoelectric material (11) with a second partial area A2, and the sensor layer (3) has a conductivity that is dependent on environmental influences, so that the piezoelectric material (11) can be excited to vibrate by means of electrical potentials from an excitation unit for generating electrical potentials (13), both by way of the excitation electrodes (7, 9) and by the sensor layer (3), and the resonance frequency of a vibration order of the piezoelectric material (11) can be detected by means of a frequency measurement device (17), and a third excitation electrode (27) is disposed on the second side of the piezoelectric material, which lies against the piezoelectric material (11) with an area A3, which is at least as large as the partial area A2 of the sensor layer (3) and, if this partial area A2 is projected onto the area A3, the partial area A2 is completely covered by the area A3, and the first, second, and third excitation electrode are electrically connected with a switching means (29) that connects the second (9) and third (27) excitation electrode in electrically conductive manner in a first switching position, so that the conductivity of the sensor layer (3) can be detected, and the switching means (29) connects the first and third excitation electrode (27) in electrically conductive manner in a second switching position, so that the change in the vibration properties caused by deposit of substance of the environmental influence can be measured.

28. Sensor device according to claim 27, wherein the first excitation electrode (7) is formed in the shape of a circular disk on one side of the piezoelectric material.

29. Sensor device according to claim 27, wherein the second excitation electrode (9) is formed in the shape of a circular disk, and the third excitation electrode (27) is formed in the shape of a circular ring (31).

30. Sensor device according to claim 27, wherein the sensor layer (3) lies directly against the first excitation electrode and is circular.

31. Sensor device according to claim 27, wherein the piezoelectric material is formed in the shape of a cylinder (19), whereby the first, second, and third excitation electrode (27) as well as the piezoelectric material and the piezoelectric material have a common axis of symmetry.
